(19) United States
(12) Patent Application Publication
(10) Pub. No.: US 2010/0071189 A1
(43) Pub. Date: Mar. 25, 2010

(54) METHOD FOR PLACING HEADERS AND DEVICE FOR IMPLEMENTING METHOD

(75) Inventors: Tapio Korhonen, Louhi (FI); Risto Laukkanen, Savonlinna (FI); Esa Nuutinen, Savonlinna (FI); Ari Partanen, Savonlinna (FI); Juha Pitkänen, Savonlinna (FI)

Correspondence Address: BIRCH STEWART KOLASCH & BIRCH, PO BOX 747, FALLS CHURCH, VA, 22040-0747, US

(73) Assignee: SAIMATEC ENGINEERING OY, Savonlinna (FI)

(21) Appl. No.: 12/561,009

(22) Filed: Sep. 16, 2009

(30) Foreign Application Priority Data
Sep. 17, 2008 (FI) 2008 5872

(51) Int. Cl. B23P 11/00

(52) U.S. Cl. 29/428; 29/281.6

(57) ABSTRACT

A method for placing headers in connection with the packing of paper, cardboard, pulp or equivalent web material reels, in which method, one multiaxis industrial robot (1) or equivalent apparatus picks inner headers (2) and outer headers (9) to be placed in the paper reel from storage racks or places (3, 3′, 10, 10′). The invention is implemented such that the inner headers (2) and/or the outer headers (9) are transferred to placing manipulators (4) which move in the longitudinal axial direction of the paper reel and take the inner headers (2) at the heads of the paper reel (5) and/or equivalently the outer headers (9) onto head press planes (11) with a motion in the longitudinal axial direction of the paper reel (6) and in its cross direction (7) or a combination of these motions.

This invention relates to a method for placing headers in connection with the packing of paper, cardboard, pulp or equivalent web material reels, in which method, one multiaxis industrial robot or equivalent apparatus picks inner headers and outer headers to be placed in the paper reel from storage racks or places. The invention further relates to a device for implementing the method.

As the invention is most commonly utilised in connection with the packing of paper reels, this application refers to all web material reels with the common term paper reel.

Paper reels are packed such that against their heads are typically placed thick inner headers which are substantially of the size of the reel head. The material of the inner header is corrugated board, millboard or other laminar material. The inner headers are placed at the heads of the reel before winding a wrapper around the reel. The inner headers are kept in place by air blowing or holders at the start of the wrapping step. The task of the inner header is to operate as mechanical protection when storing and transporting paper reels in the vertical position.

Two layers of wrapper are usually wound around the reel jacket such that the edges of the wrapper extend over the heads. After that, the edges of the wrapper are folded on top of the inner headers, whereby they stay in place. The wrapper is typically two-layered, so-called laminate paper in which there is between paper layers a plastic layer which operates as a moisture barrier.

After the wrapping and the folding of the edges, at the reel heads are fastened outer headers which are as well substantially of the size of the reel head. The material of the outer headers is typically elastic board one side of which is coated with plastic. The outer headers are fastened with a head press by pressing the headers with hot press planes at the heads of the paper reel. The headers are fastened with a thermal plastic grip on top of the folded wrapping edges as well as to the inner header and thus close the package. The plastic coating of the outer header also operates as a moisture barrier of the package.

The placing and fastening of inner and outer headers in the paper reel and wrapping operations take place either together or in several work stations depending on how large the capacity of the packing system is and how the work steps have otherwise been arranged. The travel of reels inside the packing system and out of it can occur either in the radial direction by rolling or in the axial direction by transferring e.g. by a conveyor or a carriage. The travel of the paper reel inside and out can occur e.g. in one direction by rolling and in the other direction by transferring in the axial direction. The transfer way of the reel inside and out of the packing system is determined case-specifically depending on capacity, reel conveying system and/or available space.

Industrial robots are commonly used in handling headers such that the inner headers have their own robotised placing system and the outer headers equivalently have their own system. This is indeed a suitable arrangement in such reel packing systems which include separate work stations for reel wrapping and head pressing. Such systems typically provide a high capacity. Robotised header placing systems are commonly used in such reel packing systems which require a capacity of over 100 reels per hour. The robotised header systems are used in high-capacity reel packing systems for ergonomic reasons, because the fast and routine handling of headers is not sensible manually and working aside rotating machines and mobile paper reels is not safe.

Instead in lower-capacity reel packing systems, the headers are still commonly placed by hand. In such systems, the wrapping and head pressing typically occur in the same station, which facilitates the work of the operator. The system capacity is in practice at the most 60 reels per hour and typically one operator works there placing both the inner and outer headers. If a higher capacity is required, the wrapping and head pressing steps have to be done in different stations, whereby at least two operators are required for the manual handling of headers and shipping labels.

Due to the development of paper production and industrial safety, an increased requirement exists to provide reel packing systems of lower capacity with automatic header placing systems. Then, there is also a need to change systems earlier operated manually into totally automatic systems.

Existing manual reel packing systems do not often have enough room for separate inner and outer header handling systems provided with robots. The investment costs of a two-robot system are also unnecessarily high when the capacity of one robot is sufficient for handling both inner and outer headers.

Patent FI117168 described a method and arrangement for placing reel headers operated by one industrial robot, portal manipulator or operator. The key teaching of this patent is that stacks of inner and outer headers are located within the operating area of one operator or automatic header placer and that the actor (operator or automatic header placer) is able to place both headers in their places in the various steps of reel packing. For implementing this in accordance with the teaching of patent 117168, the travel direction of the reel is always deviated between the wrapping station and the press station. A limiting factor of this method and arrangement is that, therein, paper reels are brought to the wrapping station and removed from the wrapping station always on a conveyor by transferring in the axial direction. Another limiting factor is that the motion direction of the reel is changed between the placing of inner headers and outer headers. These factors limit the use of the method and arrangement in accordance with the reference patent only to packing systems fulfilling the above qualifications. The method according to the patent cannot be employed in conventional packing systems, in which the travel direction of the reels is not changed between the packing steps, or in such packing systems, in which the transfer of the paper reel occurs by rolling to the wrapping station and/or away from it. Furthermore, the arrangement according to the patent is not applicable to such packing systems in which wrapping and head press operations are in the same station. Generally, it is not either applicable to the automation of existing manual packing systems. The range of use of the header placing method and arrangement in accordance with patent FI117168 is thus very limited.

The object of the invention is to provide a method and a device for packing paper reels, in which method and device no above-described problems are related. The method according to the invention is characterised by transferring inner headers and/or outer headers to placing manipulators which move in the longitudinal axial direction of the paper reel and take the inner headers at the heads of the paper reel and/or equivalently the outer headers onto head press planes with a motion in the longitudinal axial direction of the paper reel and in its cross direction or a combination of these motions.

An advantageous embodiment of the method according to the invention is characterised by taking the inner headers at the heads of paper reels and taking the outer headers onto the head press planes in different operation steps of the placing manipulators.

Another advantageous embodiment of the method according to the invention is characterised by taking the inner headers at the heads of paper reels and taking the outer headers onto the head press planes in the same operation step of the placing manipulators.

A further advantageous embodiment of the method according to the invention is characterised by keeping the inner headers fast on gripping elements of the placing manipulators being opposite in relation to each other and equivalently keeping the outer headers fast on gripping elements of the placing manipulators being away from each other.

The device implementing the method according to the invention and its advantageous embodiments are characterised by what is stated in claims 5-8.

In the method and device according to this invention, there is one picking robot or equivalent picking apparatus and header placing manipulators.

The method and device are applicable in connection with packing systems of various device arrangements. They are applicable to both the automation of existing manual packing systems and the implementation of new packing systems.

The method and device according to the invention enable implementing the picking and placing of inner headers and outer headers in several alternative ways. The automatic handling system of headers can always be implemented advantageously observing different device arrangements, capacity requirements, available space and other such factors.

The automation of existing packing systems intensifies the productivity of paper mills without the need for large investments in new reel handling devices which often require also expensive building investments.

Next, the invention will be described in more detail by means of examples of advantageous embodiments with reference to the accompanying drawings in which

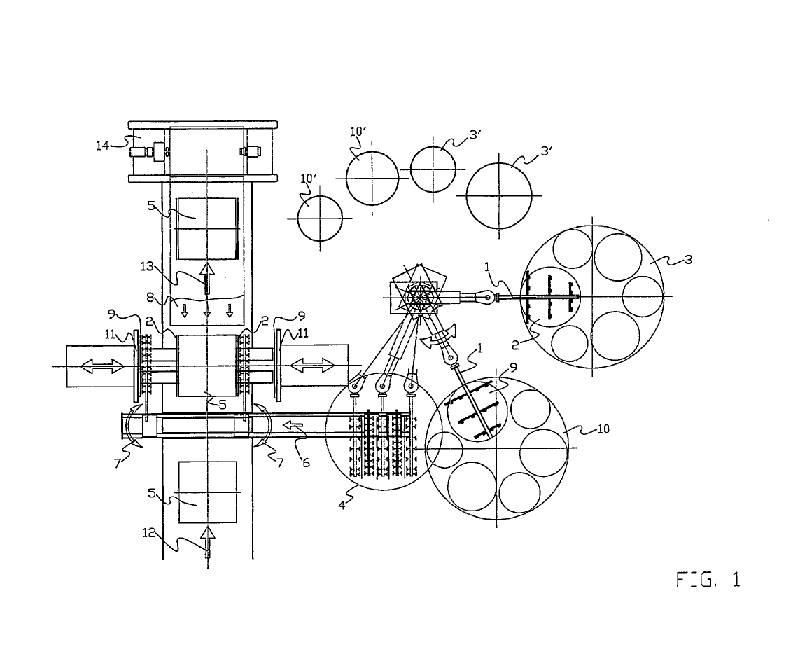

FIG. 1 shows a top view of the operating principle of a device according to an advantageous embodiment of the invention.

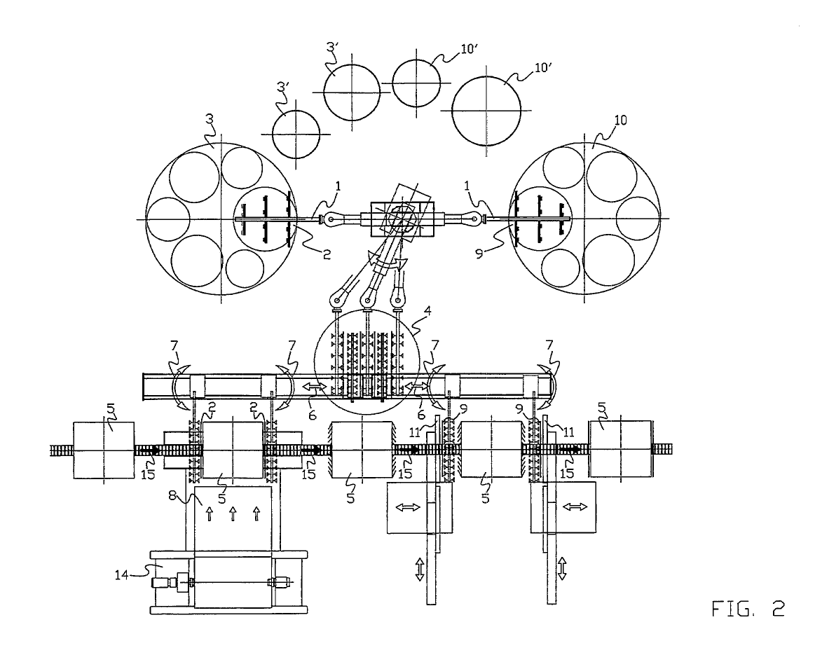

FIG. 2 shows a top view of the operating principle of a device according to a second advantageous embodiment of the invention.

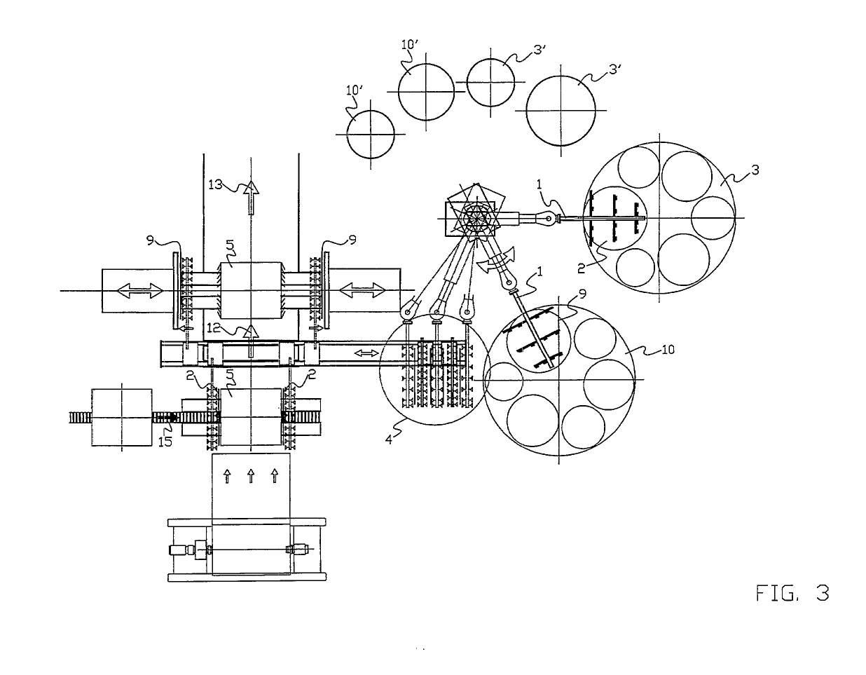

FIG. 3 shows a top view of the operating principle of a device according to a third advantageous embodiment of the invention.

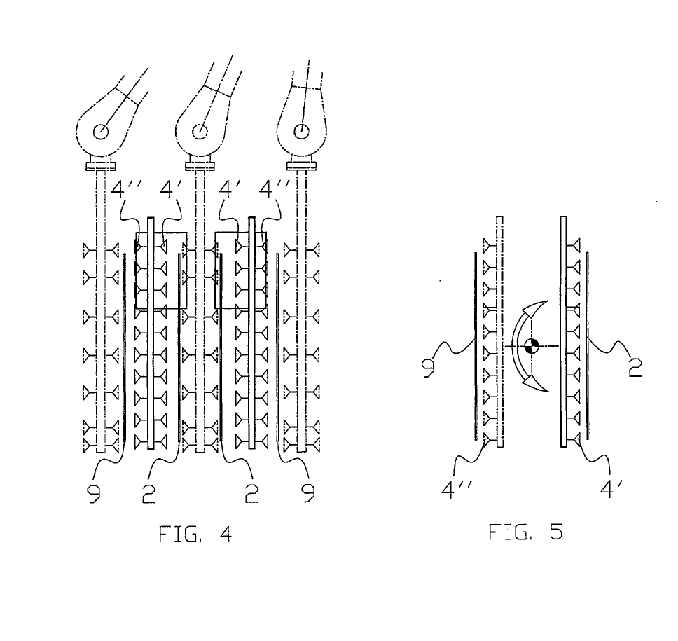

FIG. 4 shows a side view of gripping mechanisms of a placing manipulator.

FIG. 5 shows a side view of a gripping mechanism of a rotating placing manipulator.

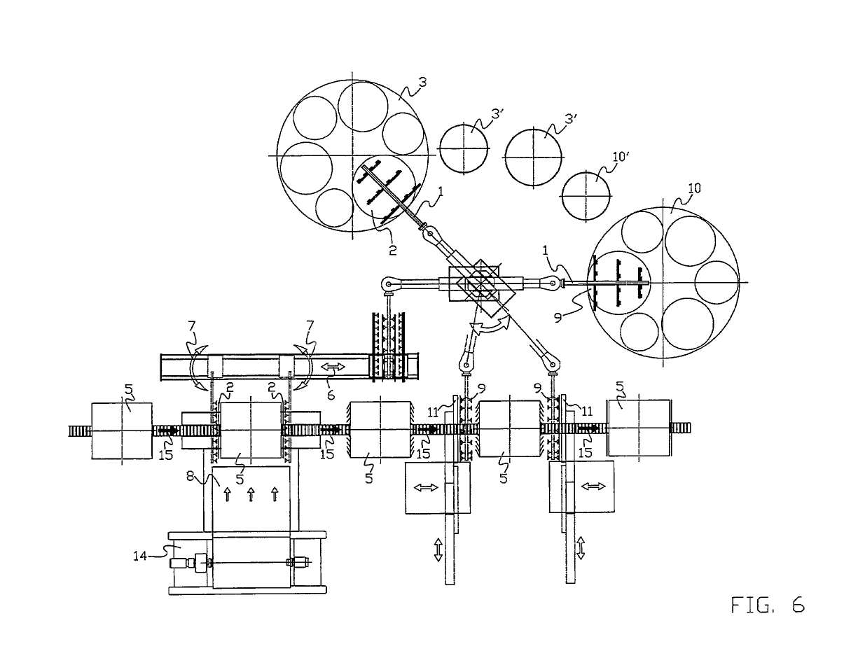

FIG. 6 shows a top view of the operating principle of a device according to a fourth advantageous embodiment of the invention.

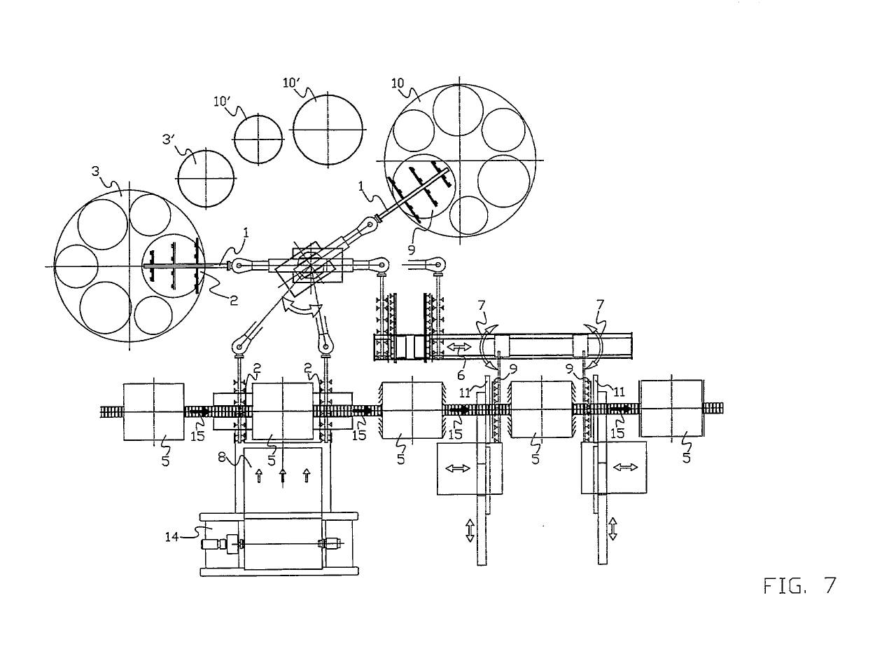

FIG. 7 shows a top view of the operating principle of a device according to a fifth advantageous embodiment of the invention.

In the first step, a robot 1 picks for both paper reels two inner headers 2 from a storage rack 3 or place 3′ and transfers them to placing manipulators 4. The placing manipulators transfer the inner headers in the axial direction 6 of the paper reel 5 and take them with a cross-directional motion 7 at the heads of the reel before winding a wrapper 8 around the reel, one header for each side of the reel. The inner headers are kept in place by air blowing or holders at the start of the wrapping step.

Equivalently in the second step, the robot picks two outer headers 9 from a storage rack 10 or place 10′ and transfers them to the placing manipulators 4 which transfer the outer headers in the axial direction of the reel and place them with a cross-directional motion onto head press planes 11 on which they are taken fast with suction. The outer headers are fastened at the heads of the paper reel in a way described above.

The placing manipulators 4 are advantageously dual-operational, i.e. they have the same operating mechanisms for transferring both inner and outer headers at the heads of the reel 5 and equivalently onto the press planes 11. However, they advantageously have separate vacuum-driven gripping mechanisms, typically suction cups 4′, 4″, for inner and outer headers. The separate gripping mechanisms are required because the inner header is gripped from different side than the outer header. The separate gripping mechanisms also provide the benefit that the inner and outer headers can be handled simultaneously. The gripping mechanisms are illustrated in FIG. 4.

However, there is no requirement for separate gripping mechanisms for the inner and outer headers if it is designed rotatable around. Then, it is only possible to handle one header, either an inner or outer header, at a time. This embodiment is shown in FIG. 5.

The motion distance of the placing manipulators is not limited, which provides various possibilities for locating header storage racks or places and picking robots into connection with the packing system. As the storage racks are typically used rotating storage tables 3, 10, fixed storage places 3′, 10′ positionable on the floor or both depending on how many header sizes of each type 2, 9 are required for covering the whole size range. The storage racks or places are located such that the picking robot is able to handle the headers of both types.

The wrapping and head press steps can be located in the same station, whereby the packing system is very compact. Such a system is shown in FIG. 1. When the wrapping and head press steps are located in different stations, the method provides a larger capacity. Such an arrangement is illustrated in FIGS. 2 and 3.

The paper reels can come to the wrapping station and the head press station by rolling 12 and also leave them by rolling away 13. The transfer of the reel by rolling is advantageous, because no conveyor is then required to transfer it. The transfer of the paper reel by rolling between the work steps is also advantageous from the viewpoint of space utilisation of devices. When the paper reels come rolling to the wrapping station and leave in the same direction, the wrapper reels and feed stations 14 are located above the rolling plane. The wrapper is then led around the reel with a special guide. FIG. 1 shows this embodiment.

In the method according to the invention, the paper reel can be transferred in the wrapping step inside and out and equivalently in the head press step inside and out also in the axial direction 15 by a conveyor or a carriage. With such a system, the transfer of the reel is more controlled and, if required, quicker than the one taking place by rolling. Such an arrangement is shown in FIG. 2.

It is also possible to transfer the reel both by axially transferring 15 in one work step and by rolling 12, 13 in the second work step (FIG. 3).

It is obvious to those skilled in the art that the invention is not limited to the embodiment examples described above, but it can be applied to various device arrangements which fulfill the characteristic features according to the claims.

The patent drawings illustrate only one wrapper reel, but the number of reels is not substantial from the viewpoint of the invention. The invention can be applied in connection with reel packing systems provided with various device arrangements. The number of wrappings and wrapping stations can be e.g. 2-10 depending on the work width of the system.

The patent drawings describe a system in which the wrapper extends over both heads of the paper reel such that both edges of the same wrapper are folded on top of inner headers. The invention can also be employed in reel packing systems in which the wrapper consists of two or more parallel overlapping wrappers and in which the edges of the outermost wrappers extend over the head of the reel and are folded on top of the header.

It is thus possible to utilise the invention in a reel packing system operating with the so-called spiral wrapping principle in which only the so-called edge rims extend over the head of the reel and are folded on top of the header.

It is also possible to use the method and device according to the invention such that the placing manipulators 4 place only either inner or outer headers and the robot equivalently places second headers directly at the heads of the reel or onto the press planes. The key characteristic of the invention is that the motion distance of the placing manipulators is so long that they reach from the range of the picking robot to each delivery place of headers. Such alternative embodiments are described in FIGS. 6 and 7.

1. A method for placing headers in connection with the packing of paper, cardboard, pulp or equivalent web material reels, in which method, one multiaxis industrial robot (1) or equivalent apparatus picks from storage racks or places (3, 3′, 10, 10′) inner headers (2) and outer headers (9) to be placed in the paper reel, characterised by transferring the inner headers (2) and/or the outer headers (9) to placing manipulators (4) which move in the longitudinal axial direction of the paper reel and taking the inner headers (2) at the heads of the paper reel (5) and/or equivalently the outer headers (9) onto head press planes (11) with a motion in the longitudinal axial direction of the paper reel (6) and in its cross direction (7) or a combination of these motions.

2. A method according to claim 1, characterised by taking the inner headers (2) at the heads of the paper reels and taking the outer headers (9) onto the head press planes (11) in different operation steps of the placing manipulators.

3. A method according to claim 1, characterised by taking the inner headers (2) at the heads of the paper reels and taking the outer headers (9) onto the head press planes (11) in the same operation step of the placing manipulators.

4. A method according to claim 1, characterised by keeping the inner headers fast on gripping elements (4′) of the placing manipulators (4) being opposite in relation to each other and equivalently keeping the outer headers fast on gripping elements (4″) of the placing manipulators being away from each other.

5. A device for placing headers in connection with the packing of paper, pulp, cardboard or equivalent web material reels, which device includes:
storage racks or places (3, 3′; 10, 10′) for inner and outer headers of various sizes,
an industrial robot or equivalent picking apparatus (1) advantageously provided with gripping elements for picking and transferring the inner and outer headers (2, 9) from the storage racks or places to a placing manipulator combination (4)
characterised in that
the placing manipulator combination (4) is arranged to move in the longitudinal axial direction (6) of the paper reel (5) and between a reception place and delivery places of inner headers and outer headers, that
in the placing manipulator combination, there are elements for holding the inner headers fast and for delivering them at the heads of the paper reels, and that
in the placing manipulator combination, there are elements for keeping the outer headers fast and for delivering them onto head press planes.

6. A device according to claim 5, characterised in that the elements for keeping the inner header and outer header coming onto the same side of the paper reel fast and for delivering them are combined such that their gripping elements are located on opposite sides (4′, 4″).

7. A device according to claim 6, characterised in that the elements for keeping the inner headers and outer headers coming to different sides of the paper reel fast and for delivering them operate separately and are mirror images in relation to each other.

8. A device according to claim 5, characterised in that the elements for keeping the inner header and outer header coming onto the same side of the paper reel fast and for delivering them are rotatable around

9. A method according to claim 2, characterised by keeping the inner headers fast on gripping elements (4′) of the placing manipulators (4) being opposite in relation to each other and equivalently keeping the outer headers fast on gripping elements (4″) of the placing manipulators being away from each other.

10. A method according to claim 3, characterised by keeping the inner headers fast on gripping elements (4′) of the placing manipulators (4) being opposite in relation to each other and equivalently keeping the outer headers fast on gripping elements (4″) of the placing manipulators being away from each other.
